(19) United States
(12) Patent Application Publication
(10) Pub. No.: US 2011/0155008 A1
(43) Pub. Date: Jun. 30, 2011

(54) DOUBLE-SIDED IMPRINT APPARATUS

(75) Inventors: Noritake SHIZAWA, Kamisato (JP); Kyoichi Mori, Kamisato (JP); Takashi Tarumitsu, Kamisato (JP); Toshimitsu Shiraishi, Kamisato (JP)

(73) Assignee: Hitachi High-Technologies Corporation

(21) Appl. No.: 12/975,411

(22) Filed: Dec. 22, 2010

(30) Foreign Application Priority Data
Dec. 25, 2009 (JP) 2009-294119

(51) Int. Cl. B41F 1/18

(52) U.S. Cl. 101/450.1

(57) ABSTRACT

The present invention relates to a double-sided imprint apparatus capable of simultaneously imprinting both surfaces of a transfer printing target such as a doughnut-shaped, circular disc substrate. The double-sided imprint apparatus includes: an upper surface stamper device that is supported by an elevation mechanism; a lower surface stamper device that is fastened to a transport table mounted on a guide rail; and a transfer printing target separator, in which the transport table moves back and forth along the guide rail with the aid of a transport drive mechanism, thereby allowing the lower surface stamper device and the transfer printing target separator to alternately move to a position facing the upper surface stamper device, which is positioned at the center of the upper surface stamper device.

### BACKGROUND OF THE INVENTION

1. Field of the Invention

The present invention relates to an imprint apparatus that forms a microstructure on a surface of a transfer printing target, and more particularly, to a double-sided imprint apparatus suitable for applications where a microstructure is to be formed on both surfaces, for instance, of a discrete track medium.

2. Description of the Related Art

Due to remarkable functional enhancement of computers and various other information devices, the amount of information handled by a user has continuously increased from the gigabyte range to the terabyte range. Under these circumstances, there is an increasing demand for information recording/reproducing devices, memories, and other semiconductor devices having a higher recording density.

To obtain an increased recording density, it is necessary to use a finer processing technology. A conventional optical lithography based on an exposure process makes it possible to perform large-area microfabrication at one time. However, the conventional optical lithography is not suitable for fabricating a microstructure finer than an optical wavelength, for instance, of 100 nm because it does not have a resolution smaller than the optical wavelength. For example, an exposure technology based on an electron beam, an exposure technology based on X-rays, and an exposure technology based on ion lines are available as a technology for fabricating a microstructure finer than the optical wavelength. However, pattern formation by an electron beam drawing apparatus differs from pattern formation by a one-shot exposure method that uses, for instance, i rays or a light source such as an excimer laser. More specifically, when an electron beam drawing apparatus is used, the time required for drawing (exposure) increases with an increase in the number of patterns to be drawn by an electron beam. Therefore, an increase in the recording density increases the time required for the formation of a micropattern, thereby causing a significant decrease in manufacturing throughput. Meanwhile, an electron-beam cell projection lithography, which irradiates a combination of variously-shaped masks with an electron beam at a time, is being developed in order to increase the speed of pattern formation by an electron beam drawing apparatus. However, an electron beam drawing apparatus using the electron-beam cell projection lithography increases in size and additionally requires a mechanism for controlling the mask position with increased accuracy. This raises the cost of the drawing apparatus, thereby causing various problems such as an increase in the cost of media manufacture.

As a technology for fabricating a microstructure finer than the optical wavelength, a printing technology is proposed in place of the conventional exposure technologies. For example, a nanoimprint lithography (NIL) technology is disclosed in U.S. Pat. No. 5,772,905. The nanoimprint lithography (NIL) technology prepares an original plate (mold) on which a predetermined microstructure pattern is formed by using an electron beam exposure technology or other technology for fabricating a microstructure finer than the optical wavelength, presses the prepared original plate against a resist-coated transfer printing target substrate, and transfers the microstructure pattern on the original plate to a resist layer of the transfer printing target substrate. As far as the original plate is prepared, the nanoimprint lithography (NIL) technology can mass-produce replicas with a common printer-like apparatus without using an expensive exposure apparatus. This makes it possible to achieve a considerably higher throughput than, for instance, the electron beam exposure technology and greatly reduce the cost of manufacturing. The apparatus used to achieve such a purpose is referred to, for instance, as a “microstructure transfer printing apparatus” or “imprint apparatus.”

When thermoplastic resin is employed as resist during the use of the nanoimprint lithography (NIL) technology, the pressurization and transfer printing processes are performed at a temperature close to or higher than the glass-transition temperature (Tg) of an employed material. This method is referred to as a thermal transfer method. The thermal transfer method is advantageous in that general-purpose thermoplastic resin can be widely used. When, on the other hand, photosensitive resin is used as a resist, transfer printing is performed with photocurable resin that hardens when exposed to light such as ultraviolet rays. This method is referred to as an optical transfer method.

When a nanoimprint process is to be performed by the optical transfer method, it is necessary to use special photocurable resin. When compared to the thermal transfer method, however, the optical transfer method is at an advantage in that it minimizes the dimensional error in a finished product that may be caused by the thermal expansion of a transfer printing plate or printing target member. Further, the imprint (microstructure transfer printing) apparatus based on the optical transfer method is advantageous in that it does not need a heating mechanism or other additional devices, for instance, for warming, temperature control, and cooling, and does not have to consider design factors such as thermal insulation and other provisions against thermal strain.

An example of the imprint (microstructure transfer printing) apparatus based on the optical transfer method is described in US Publication Number 2008/0042319. This apparatus is configured so as to press an ultraviolet-transmitting stamper against a transfer printing target substrate to which photocurable resin is applied, and irradiate the stamper with ultraviolet rays from above. It should be noted that a predetermined microstructure pattern is formed on the transfer printing target substrate pressure surface of the stamper.

As described in U.S. Pat. No. 5,772,905 and US Publication Number 2008/0042319, the conventional imprint apparatuses mainly form a predetermined microstructure pattern on only one surface of a transfer printing target. Recently, however, it is strongly demanded that a microstructure pattern be formed on both surfaces, as in the case of discrete track media, in order to further increase the recording density.

### SUMMARY OF THE INVENTION

Both surfaces of a transfer printing target, such as a doughnut-shaped, circular disc substrate, can be imprinted by imprinting one surface and the other surface alternately while the remaining back surface is maintained in an uncontacted state. When this method is used, the back surface, however, which is not currently imprinted, is the surface to be imprinted next or the surface already imprinted. For high-quality imprinting, it is generally demanded that the surface to be imprinted be smooth and free from foreign matters. Further, the microstructure pattern on the imprinted surface must not be damaged by bringing it into mechanical contact with an object. Therefore, when the employed method imprints one surface and the other surface alternately, the work must be retained during imprinting in such a manner that the back surface remains in an uncontacted state. This makes it necessary to furnish a press with a complex noncontact mechanism. Furthermore, an imprinting operation needs to be performed twice because the front and back surfaces are to be imprinted on an individual basis. This makes it necessary to use two units of the press. If an automatic system is used, a handling operation needs to be performed to switch between the two units of the press. As a result, the method of imprinting one surface and the other surface alternately not only decreases the throughput, but also increases the cost of manufacturing due to the use of complex equipment.

The present invention has been made in view of the above circumstances and provides a double-sided imprint apparatus capable of simultaneously imprinting both surfaces of a transfer printing target such as a doughnut-shaped, circular disc substrate.

According to an embodiment of the present invention, there is provided a double-sided imprint apparatus including an upper surface stamper device, a lower surface stamper device, and a transfer printing target separator. The upper surface stamper device is supported by an elevation mechanism. The lower surface stamper device is fastened to a transport table mounted on a guide rail. A transport drive mechanism allows the transport table to move back and forth along the guide rail. This ensures that the lower surface stamper device and the transfer printing target separator can alternately move to a position facing the upper surface stamper device, which is positioned at the center of the upper surface stamper device.

In the double-sided imprint apparatus according to an embodiment of the present invention, the lower surface stamper device and the transfer printing target separator are integrally fastened to the transport table mounted on the guide rail. Therefore, the lower surface stamper device and the transfer printing target separator can move back and forth from the position of the upper surface stamper device. Therefore, when, for instance, a disc coated with uncured resist is to be placed on the lower surface stamper device, the lower surface stamper device shifts from the position facing the upper surface stamper device so that the transfer printing target separator faces the upper surface stamper device. When the disc coated with uncured resist is placed on the lower surface stamper device, the lower surface stamper device moves to the position facing the upper surface stamper device. The upper surface stamper device is then lowered to perform a double-sided transfer printing operation. Next, the upper surface stamper device ascends to separate the transfer-printed disc from the lower surface stamper device. Subsequently, the transfer printing target separator moves to face the upper surface stamper device and separates the transfer-printed disc from the upper surface stamper device. In this instance, the next coated disc can be placed on the lower surface stamper device. Finally, the transfer-printed disc, which is retained by the transfer printing target separator, can be taken out by shifting the transfer printing target separator from the position facing the upper surface stamper device. As mentioned above, since the next coated disc is already placed on the lower surface stamper device, the double-sided transfer printing operation can be immediately continued when the upper surface stamper device descends toward the lower surface stamper device. As described above, the double-sided imprint apparatus according to an embodiment of the present invention can imprint both surfaces of a transfer printing target continuously and efficiently with the aid of one unit of a pressing mechanism. This makes it possible to simplify the structure of equipment and significantly increase the throughput.

The double-sided imprint apparatus according to an embodiment of the present invention is advantageous in that the lower surface stamper device and the transfer printing target separator integrally move back and forth from the position of the upper surface stamper device. Therefore, both surfaces of a transfer printing target can be simultaneously imprinted with the aid of one unit of the pressing mechanism. Further, this transfer printing operation can be performed continuously and efficiently. This makes it possible to simplify the structure of equipment and significantly increase the throughput.

These features and advantages of the invention will be apparent from the following more particular description of a preferred embodiment of the invention, as illustrated in the accompanying drawings.

### BRIEF DESCRIPTION OF THE DRAWINGS

FIG. 1 is a schematic cross-sectional view illustrating an example of a double-sided imprint apparatus according town embodiment of the present invention;

FIG. 2 is a schematic cross-sectional view illustrating a process that is performed during a double-sided imprint operation of the double-sided imprint apparatus shown in FIG. 1;

FIG. 3 is a schematic cross-sectional view illustrating a process that is performed during a double-sided imprint operation of the double-sided imprint apparatus shown in FIG. 1;

FIG. 4 is a partial schematic cross-sectional view illustrating a state where an upper surface stamper device ascends to separate a transfer-printed disc from a lower surface stamper device in the double-sided imprint apparatus according to an embodiment of the present invention;

FIG. 5 is a schematic cross-sectional view illustrating a process that is performed during a double-sided imprint operation of the double-sided imprint apparatus shown in FIG. 1;

FIG. 6 is a partial schematic cross-sectional view illustrating a state where a transfer printing target separator separates a transfer-printed disc from the upper surface stamper device in the double-sided imprint apparatus according to an embodiment of the present invention; and

FIG. 7 is a schematic cross-sectional view illustrating a process that is performed during a double-sided imprint operation of the double-sided imprint apparatus shown in FIG. 1.

### DESCRIPTION OF THE PREFERRED EMBODIMENT

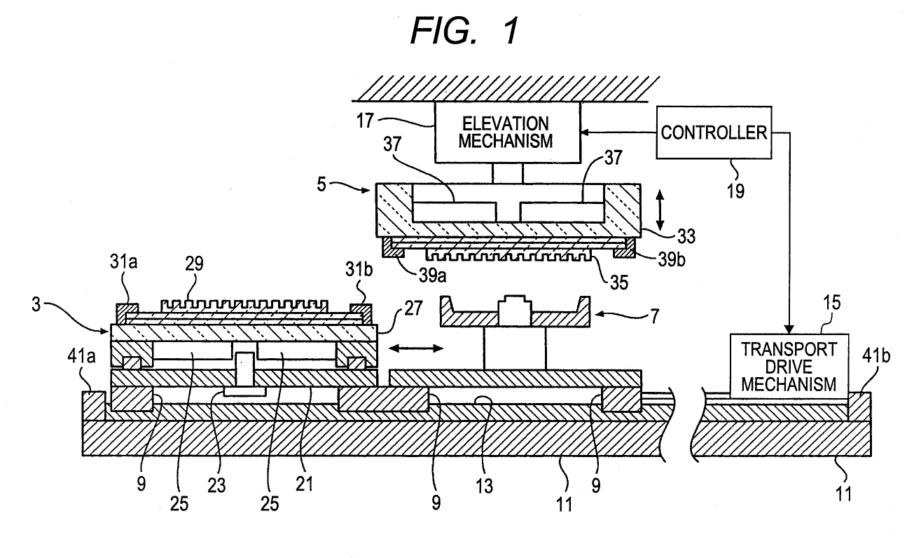

A double-sided imprint apparatus according to an embodiment of the present invention will now be described with reference to the accompanying drawings. FIG. 1 is a schematic cross-sectional view illustrating the double-sided imprint apparatus 1 according to an embodiment of the present invention. The double-sided imprint apparatus 1 basically includes a lower surface stamper device 3, an upper surface stamper device 5, and a transfer printing target separator 7. The lower surface stamper device 3 and the transfer printing target separator 7 are fastened to the upper surface of a transport table 9. The transport table 9 is mounted on a guide rail 13, which is disposed on the upper surface of a base 11. A publicly known transport drive mechanism 15, such as a stepping motor, a linear motor, or a ball screw, allows the transport table 9 to integrally move rightward and leftward along the guide rail 13. An elevation mechanism 17 causes the upper surface stamper device 5 to move up and down. A controller 19 controls the operations of the transport drive mechanism 15 and elevation mechanism 17. If necessary, stoppers 41a, 41b may be disposed on either side of the guide rail 11.

The lower surface stamper device 3 includes an XY stage 21, an alignment camera 23, a UV light source 25, a stamper mounting table 27, a lower stamper 29, and stamper clamps 31a, 31b. The stamper mounting table 27 and the lower stamper 29 are made of a light-transmissive material so that UV light incident from the UV light source 25 is transmitted through them. When a transfer printing target disc (not shown) is to be placed on the upper surface of the lower stamper 29, the alignment camera 23 is used to align the disc with the lower stamper 29. More specifically, the disc is aligned with the lower stamper 29 by moving the XY stage 21 in the X direction and/or Y direction in accordance with information detected by the alignment camera 23. Marginal ends of the lower stamper 29 are fastened to the stamper mounting table 27 with the stamper clamps 31a, 31b. As described in detail later, one of the clamp 31a and the clamp 31b can slightly move in the vertical direction. Therefore, one end of the lower stamper 29 can be released from the stamper mounting table 27. This scheme ensures that the transfer printing target disc can be separated from the lower stamper 29.

The upper surface stamper device 5 includes a stamper support table 33, an upper stamper 35, and a UV light source 37. The upper stamper 35 is positioned below the lower surface of the stamper support table 33. The stamper support table 33 and the upper stamper 35 are made of a light-transmissive material so that UV light incident from the UV light source 37 is transmitted through them. The upper stamper 35 is fastened to the stamper support table 33 with clamps 39a, 39b. As described in detail later, one of the clamp 39a and the clamp 39b can slightly move in the vertical direction. Therefore, one end of the upper stamper 35 can be released from the stamper support table 33. This scheme ensures that the transfer printing target disc can be separated from the upper stamper 35.

As described in detail later, when the double-sided imprint apparatus 1 according to the present embodiment performs a double-sided imprint process on a transfer printing target disc, the disc can be separated from the lower stamper 29 of the lower surface stamper device 3, but remains closely attached to the upper stamper 35 of the upper surface stamper device 5. Therefore, the transfer printing target separator 7 is used to separate the disc from the upper stamper 35 of the upper surface stamper device 5.

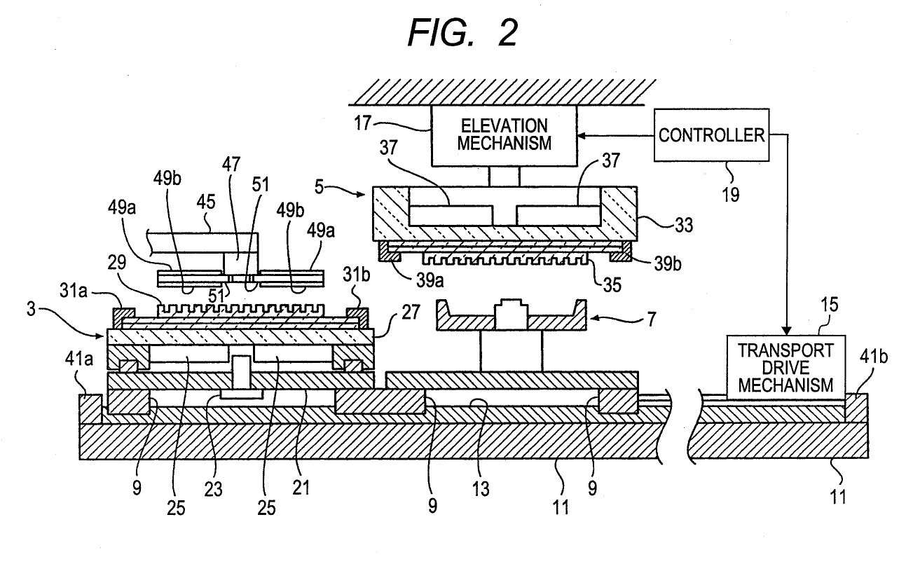

FIG. 2 is a schematic cross-sectional view illustrating a state where a disc 43 is placed on the lower stamper 29 of the lower surface stamper device 3 when a double-sided imprint operation is performed by the double-sided imprint apparatus 1 according to the present embodiment, which is shown in FIG. 1. After the surfaces of both sides of the disc 43 are coated with photocurable resist, the disc 43 is transported by a disc chuck 47, which is attached to the leading end of a disc handling arm 45. Since the outer circumferential edge of the disc 43 is also coated with resist 49a, 49b, it cannot be chucked for the purpose of transporting the disc. However, an area 51 around a central through-hole in the disc 43 is not coated with the resist 49a, 49b. It is therefore preferred that the area 51, which is not coated with the resist, be vacuum-retained by the disc chuck 47 for transportation purposes. It is also preferred that the disc handling arm 45 be capable of moving up and down and rotating or moving back and forth. When the disc 43 is transported to a position directly above the lower stamper 29 by the disc handling arm 45, the alignment camera 23 of the lower surface stamper device 3 detects the center of the inside diameter of the disc 43 and an alignment mark at the center of the lower stamper 29. In accordance with a signal detected by the alignment camera 23, the XY stage 21 is driven to align the disc 43 with the lower stamper 29. When the disc 43 is aligned with the lower stamper 29, the disc handling arm 45 descends to place the disc 43 on the surface of the lower stamper 29. After the disc chuck 47 is deactivated to provide vacuum relief, the disc handling arm 45 retracts. Both surfaces of the disc 43 can be coated with the resist 49a, 49b by using a publicly known coating method such as spin coating, spray coating, roll coating, or inkjet coating. As for double-sided spin coating of a disc, a double-sided spin coater is commercially available from Nanometric Technology Inc., which is located in Itabashi-ku, Tokyo, Japan. A double-sided spray coater, an electrostatic spray coater, and a roll coater are commercially available from WHY Corporation Ltd., which is located in Meguro-ku, Tokyo, Japan. A device for inkjet-coating both surfaces of a disc with resist is disclosed in Japanese Patent Publication No. 2009-161494, which is filed by the applicant of the present invention.

The disc 43 is a doughnut-shaped, circular disc substrate having a central through-hole, such as a hard disk, CD, or DVD. Commonly used thin films, such as a metal layer, a resin layer, and an oxide film layer, may be formed on the surfaces of both sides of the disc 43 to build a multilayer structure. The resist 49a, 49b may be prepared, for instance, by adding a photosensitive substance to a synthetic resin material. The synthetic resin material to be used may be based, for instance, on cycloolefin polymer, polymethyl methacrylate (PMMA), polystyrene polycarbonate, polyethylene terephthalate (PET), polylactic acid (PLA), polypropylene, polyethylene, or polyvinyl alcohol (PVA). The photosensitive substance to be used may be, for instance, peroxide, azo compound (e.g., azobisisobutyronitrile), ketone (e.g., benzoin or acetone), diazoaminobenzene, metal complex salt, or dye.

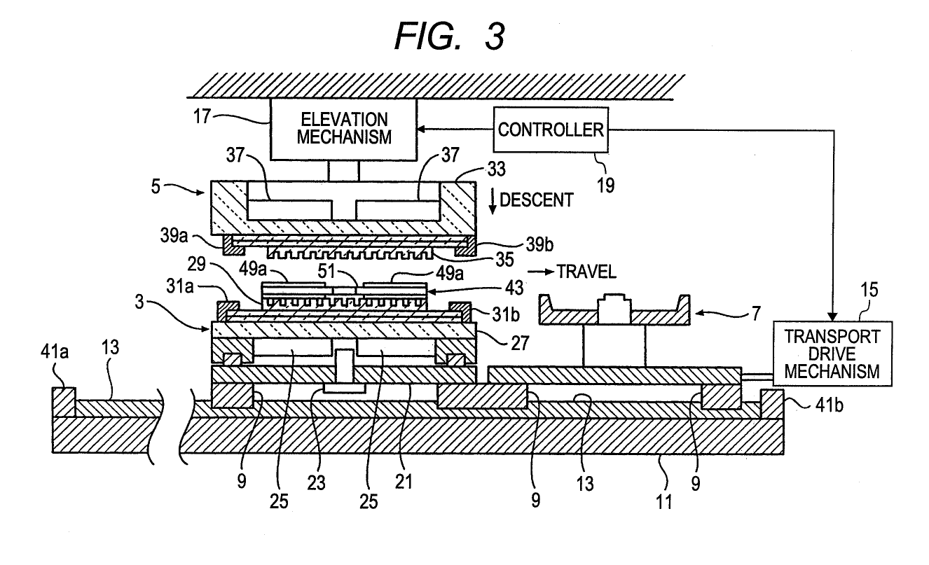

FIG. 3 is a schematic cross-sectional view illustrating a process that is performed during a double-sided imprint operation of the double-sided imprint apparatus 1 according to the present embodiment, which is shown in FIG. 1. As described with reference to FIG. 2, when the disc 43 is placed on the upper surface of the lower stamper 29 after both surfaces of the disc 43 are coated with the resist 49a, 49b, the transport drive mechanism 15 moves the transport table 9 along the guide rail 11 until the lower surface stamper device 3 moves to a position facing the upper surface stamper device 5. The lower surface stamper device 3 and the transfer printing target separator 7 then come to a stop. If needed, the alignment camera 23 of the lower surface stamper device 3 detects an alignment mark on the lower stamper 29 and an alignment mark on the upper stamper 35. In accordance with a signal detected by the alignment camera 23, the XY stage 21 is driven to align the lower stamper 29 with the upper stamper 35. When the lower stamper 29 is aligned with the upper stamper 35, the elevation mechanism 17 lowers the upper surface stamper device 5 and applies a predetermined pressure to presses the upper surface stamper device 5 against the disc 43. When the upper surface stamper device 5 tightly contacts with the disc 43, the UV light source 25 of the lower surface stamper device 3 and the UV light source 37 of the upper surface stamper device 5 are controlled to radiate UV light to harden the resist 49a, 49b. A pattern of the lower stamper 29 is then transfer-printed onto the resist 49b on the lower surface of the disc 43, and a pattern of the upper stamper 35 is transfer-printed onto the resist 49a on the upper surface. A publicly known UV light source may be used as the UV light source 25 and UV light source 37. For example, a mercury lamp, a high-pressure mercury lamp, a low-pressure mercury lamp, a xenon lamp, and a UV-LED light source may be selectively used as the UV light sources 25, 37. Particularly, the use of a UV-LED light source is preferred. The UV-LED light source is considerably smaller in size than the mercury lamp and emits ultraviolet light having a wavelength of 365 nm. Thus, the amount of heat generated by the UV-LED light source is greatly reduced. Therefore, the UV-LED light source does not adversely affect or damage an irradiated substance. In addition, the UV-LED light source is low in power consumption, environmentally friendly, and long in life (10,000 to 20,000 hours). Consequently, the UV-LED light source is at an advantage in that it reduces line downtime due to lamp replacement.

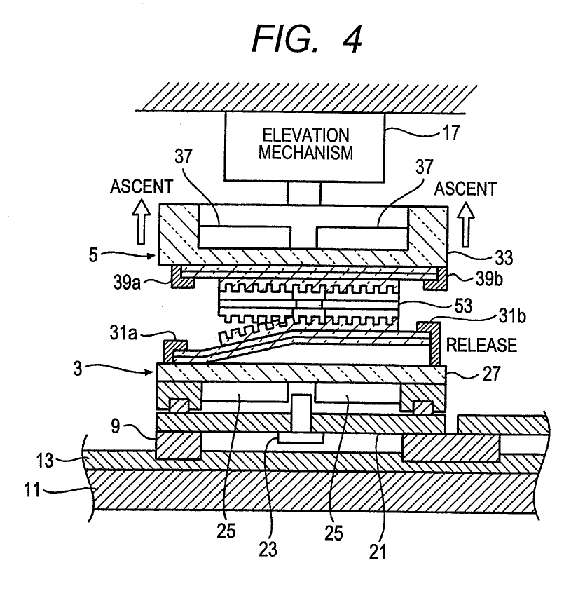

FIG. 4 is a partial schematic cross-sectional view illustrating a process that is performed during a double-sided imprint operation of the double-sided imprint apparatus 1 according to the present embodiment, which is shown in FIG. 1. As described with reference to FIG. 3, when a pattern is transfer-printed onto both surfaces of the disc 43, the resulting transfer-printed disc 53 is taken out. In such an instance, as shown in FIG. 4, while the upper stamper 35 is secured by the clamps 39a, 39b of the upper surface stamper device 5 with the lower stamper 29 secured by the clamp 31a of the lower surface stamper device 3, the clamp 31b is released to move the upper surface stamper device 5 upward. The transfer-printed disc 53 and the lower stamper 29 are then gradually separated from the clamp 31a. If such a one-end separation scheme is not used, that is, if the upper surface stamper device 5 moves upward while the upper stamper 35 is secured by the clamps 39a, 39b with the lower stamper 29 secured by the clamps 31a, 31b, the transfer-printed disc 53 cannot be separated properly from the lower stamper 29 because the force of adhesion between the stampers 29, 35 and the transfer-printed disc 53 is strong. If an attempt is made to forcibly separate the transfer-printed disc 53 from the lower stamper 29, the upper stamper 35, the lower stamper 29, and/or the disc 43 may be mechanically damaged. Although the double-sided imprint apparatus according to the present embodiment separates the transfer-printed disc 53 from the lower stamper 29, it cannot proceed to a subsequent disc taking out process unless the transfer-printed disc 53 remains closely attached to the upper stamper 35.

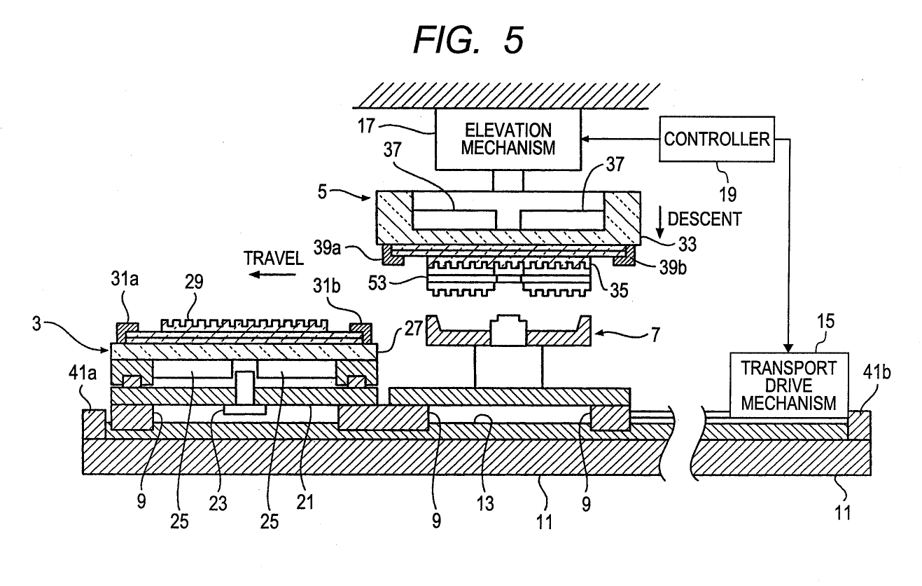

When the transfer-printed disc 53 is separated from the lower stamper 29, the transport drive mechanism 15 operates so that the lower surface stamper device 3 and transfer printing target separator 7, which are fastened to the upper surface of the transport table 9, travel along the guide rail 11 as shown in FIG. 5. The lower surface stamper device 3 and transfer printing target separator 7 stop when the transfer printing target separator 7 reaches a position facing the upper surface stamper device 5. Subsequently, the elevation mechanism 17 lowers the upper surface stamper device 5 to let the transfer-printed disc 53 engage with the transfer printing target separator 7. In this instance, the next coated disc 43 may be placed on the lower surface stamper device 3 as shown in FIG. 2.

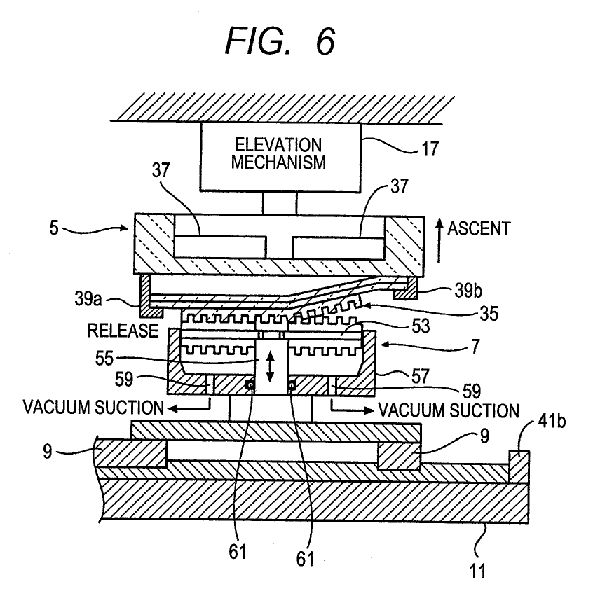

As shown in FIG. 6, a convex portion of the upper end of a disc support shaft 55 of the transfer printing target separator 7 becomes inserted into the central through-hole in the transfer-printed disc 53 so that the periphery of the transfer-printed disc 53 is latched to an inner wall surface close to the upper end of a vacuum chuck 57. Preferably, the inner wall surface of the vacuum chuck 57 enlarges toward the upper end. The bottom of the vacuum chuck 57 is provided with a vacuum suction port 59. When publicly known means such as a vacuum pump is connected to the vacuum suction port 59, the transfer-printed disc 53 can be vacuum-chucked. The disc support shaft 55 is capable of moving up and down. This mechanism is required when the transfer-printed disc 53 is to be passed to a different unloader in a subsequent process. It is therefore preferred that an O-ring 61 be disposed at a sliding contact interface between the disc support shaft 55 and the vacuum chuck 57 in order to maintain vacuum.

As shown in FIG. 6, when the clamp 39a is slightly lowered while one end of the upper stamper 35 is secured by the clamp 39b of the upper surface stamper device 5 with the transfer-printed disc 53 vacuum-engaged with the transfer printing target separator 7, the other end of the upper stamper 35 is released to move the upper surface stamper device 5 upward. The upper stamper 35 is then gradually separated from the clamp 39b. Finally, the transfer-printed disc 53 completely separates from the upper stamper 35 and remains vacuum-retained by the transfer printing target separator 7.

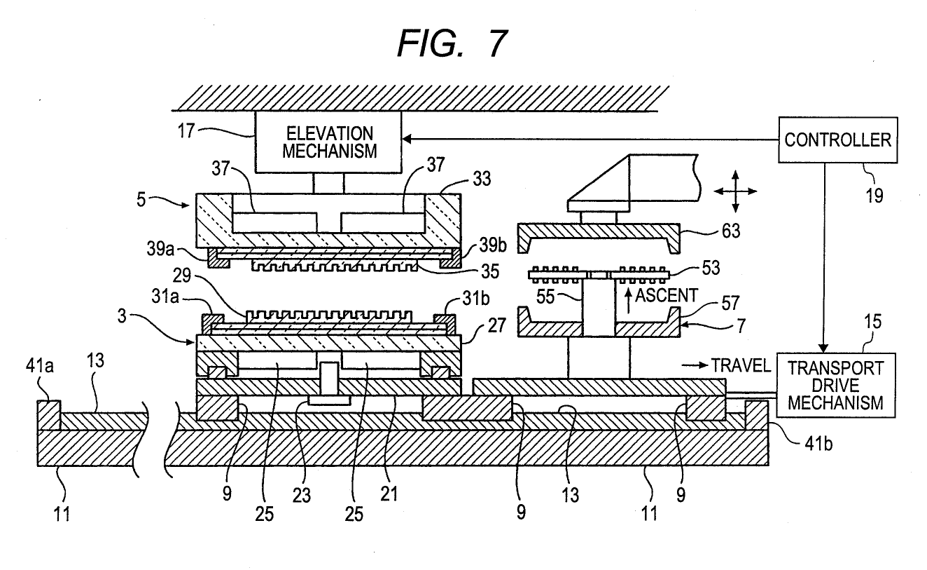

FIG. 7 is a partial schematic cross-sectional view illustrating a final process that is performed during a double-sided imprint operation of the double-sided imprint apparatus 1 according to the present embodiment, which is shown in FIG. 1. When the transfer-printed disc 53 is separated from the upper stamper 35, the lower surface stamper device 3 and transfer printing target separator 7, which are fastened to the transport table 9, travel along the guide rail 11. The lower surface stamper device 3 and transfer printing target separator 7 stop when the lower surface stamper device 3 reaches a position facing the upper surface stamper device 5. The vacuum chuck 57 of the transfer printing target separator 7 then provides vacuum relief to let the disc support shaft 55 ascend. Next, the transfer-printed disc 53 supported by the upper end of the disc support shaft 55 is taken out by an unloader 63 and placed in a product cassette (not shown).

Preferably, the unloader 63 uses a vacuum chuck type mechanism capable of moving in the X, Y, and Z directions. This type of unloader mechanism is known to a person skilled in the art. If the next coated disc 43 is already placed on the lower surface stamper device 3 as described earlier, the upper surface stamper device 5 descends to perform a transfer printing operation simultaneously with the unloading of the transfer-printed disc 53. As a result, the double-sided imprint apparatus according to the present embodiment can imprint both surfaces of a transfer printing target continuously and efficiently and increase the throughput significantly.

While the invention has been described in conjunction with a presently preferred embodiment of the invention, persons of skill in the art will appreciate that variations may be made without departure from the scope and spirit of the invention. For example, the upper surface of the stamper mounting table may be curved to prevent air bubbles from being included between a stamper and a disc coated with uncured resist. This purpose may also be achieved, for instance, by placing the whole double-sided imprint apparatus in a deaerating chamber.

The invention may be embodied in other specific forms without departing from the sprit or essential characteristics thereof. The present embodiment is therefore to be considered in all respects as illustrative and not restrictive, the scope of the invention being indicated by the appended claims, rather than by the foregoing description, and all changes which come within the meaning and range of equivalency of the claims are therefore intended to be embraced therein.

What is claimed is:

1. A double-sided imprint apparatus comprising:
an upper surface stamper device that is supported by an elevation mechanism;
a lower surface stamper device that is fastened to a transport table mounted on a guide rail; and
a transfer printing target separator;
wherein the transport table moves back and forth along the guide rail with the aid of a transport drive mechanism, thereby allowing the lower surface stamper device and the transfer printing target separator to alternately move to a position facing the upper surface stamper device, which is positioned at the center of the upper surface stamper device.

2. The double-sided imprint apparatus according to claim 1,
wherein the lower surface stamper device includes an XY stage, an alignment camera, a UV light source, a light-transmissive stamper mounting table, and a lower stamper that is fastened to an upper surface of the light-transmissive stamper mounting table with a clamp; wherein the upper surface stamper device includes an elevation mechanism, a light-transmissive stamper support table, an upper stamper that is fastened to a lower surface of the stamper support table with a clamp, and a UV light source; and
wherein the transfer printing target separator includes a vacuum chuck and a disc support shaft that is disposed at the center of the vacuum chuck and capable of moving up and down.

3. The double-sided imprint apparatus according to claim 2, wherein the clamp includes at least two clamp members, one clamp member being capable of releasing a stamper that is secured by the other clamp member.

4. The double-sided imprint apparatus according to claim 2, wherein the UV light source of the lower surface stamper device and the UV light source of the upper surface stamper device are UV-LED light sources.
